(19) United States
(12) Patent Application Publication
(10) Pub. No.: US 2018/0157189 A1
(43) Pub. Date: Jun. 7, 2018

(54) IMAGE FORMING APPARATUS

(71) Applicant: CANON KABUSHIKI KAISHA, Tokyo (JP)

(72) Inventor: Ryotaro Imine, Toride-shi (JP)

(21) Appl. No.: 15/824,307

(22) Filed: Nov. 28, 2017

(30) Foreign Application Priority Data
Dec. 5, 2016 (JP) 2016-235716

(51) Int. Cl. B41J 2/385

(52) U.S. Cl. CPC G03G 15/0415; G03G 15/0409

(57) ABSTRACT

An image forming apparatus, including: a light source; a deflection device; a lens configured to image a light beam emitted from the light source based on an image signal and deflected by the deflection device on a surface of a photosensitive member; and a controller configured to execute partial magnification correction for correcting a partial magnification as a deviation amount of a scanning speed of the light beam at a position different from a reference position in a main scanning direction with respect to a scanning speed at the reference position, wherein the controller is configured to: execute, when an image type of the image is a line image, the partial magnification correction on the image signal at a resolution less than one pixel; and execute, when the image type is a graphic image, the partial magnification correction on the image signal at a resolution in unit of one pixel.

### BACKGROUND OF THE INVENTION

### Field of the Invention

The present invention relates to an image forming apparatus including a rotary polygon mirror configured to deflect a light beam so that the light beam emitted from a light source scans a surface of a photosensitive member.

### Description of the Related Art

Hitherto, a digital copying machine, a laser beam printer, a facsimile apparatus, or other such electrophotographic image forming apparatus includes a light scanning apparatus configured to scan a surface of a photosensitive member with a light beam to form an electrostatic latent image. In the light scanning apparatus, the light beam is emitted from a light source based on image data. The light beam emitted from the light source is deflected by a rotary polygon mirror. The deflected light beam is transmitted through an imaging lens to be imaged on the surface of the photosensitive member as a light spot. The light spot imaged on the surface of the photosensitive member is moved on the surface of the photosensitive member in accordance with rotation of the rotary polygon mirror to form an electrostatic latent image on the surface of the photosensitive member. A related-art imaging lens has an fθ characteristic. The fθ characteristic represents an optical characteristic of imaging the light beam on the surface of the photosensitive member so that the light spot moves on the surface of the photosensitive member at a constant speed while the rotary polygon mirror is being rotated at a constant angular velocity. Appropriate exposure can be performed through use of an imaging lens having the fθ characteristic. However, the imaging lens having the fθ characteristic is relatively large in size and high in cost. Therefore, for the purpose of reduction in size or cost of an image forming apparatus, it is conceivable to avoid using the imaging lens having the fθ characteristic or to use a small-size low-cost imaging lens that does not have the fθ characteristic.

In an image forming apparatus using the imaging lens that does not have the fθ characteristic, the light spot imaged on the surface of the photosensitive member does not move on the surface of the photosensitive member at a constant speed, and thus there arises a problem in that an end portion of a main scanning region and a center thereof differ in width of one dot. In order to solve the problem, in Japanese Patent Application Laid-Open No. 2005-96351, there is disclosed an image forming apparatus, which uses an imaging lens that does not have an fθ characteristic, and is configured to insert or extract (hereinafter also referred to as “insert/extract”) bit data into or from each pixel so that the dot formed on the surface of the photosensitive member has a certain width. The bit data herein means a unit smaller than one pixel, which is obtained by dividing one pixel by a predetermined integer value. In this manner, the width of one dot at the end portion of the scanning region can be made equal to the width of one dot at the center of the scanning region.

However, the number of pieces of bit data to be inserted or extracted differs depending on the position in a main scanning direction, and hence there arises a problem in that a large difference in density is caused between the end portion and the center of the scanning region. The density difference conspicuously appears as a gradation step in a photograph for which gradation expression of an image is qualitatively demanded, and the density difference causes deterioration in image quality. When the image type is a graphic image, for example, a photograph, it is considered that linear interpolation magnification change (variable power processing) per pixel unit is suitable as partial magnification correction. Meanwhile, in a case of an image having a high sense of resolution and a clear light-dark border, for example, text or ruled lines, the linear interpolation may cause border rounding to adversely affect the image quality due to reduction in sense of resolution. When the image is a line image, for example, text, it is considered that insertion-extraction of bit data is suitable as the partial magnification correction.

### SUMMARY OF THE INVENTION

In view of this, the present invention provides an image forming apparatus capable of selecting a partial magnification correction method based on an image type.

According to one embodiment of the present invention, there is provided an image forming apparatus, which is configured to form an image on a recording medium, the image forming apparatus comprising:

a light source configured to emit a light beam based on an image signal generated from image data;

a deflection device configured to deflect the light beam so that the light beam emitted from the light source scans a surface of a photosensitive member in a main scanning direction;

a lens configured to image the light beam deflected by the deflection device on the surface of the photosensitive member; and

a controller configured to execute partial magnification correction for correcting a partial magnification as a deviation amount of a scanning speed of the light beam at a position, which is different from a reference position on the surface of the photosensitive member in the main scanning direction, with respect to a scanning speed of the light beam at the reference position, wherein the controller is configured to:

execute, when an image type of the image is a line image, the partial magnification correction on the image signal at a resolution less than one pixel; and

execute, when the image type is a graphic image, the partial magnification correction on the image signal at a resolution in unit of one pixel.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus.

FIG. 2A and FIG. 2B are sectional views of a light scanning apparatus.

FIG. 3 is a graph for showing a partial magnification with respect to an image height for the light scanning apparatus.

FIG. 4A and FIG. 4B are explanatory diagrams of a method of determining an image type of an original in a copying operation.

FIG. 5 is a block diagram of an exposure control system within the image forming apparatus.

FIG. 6A and FIG. 6B are timing charts of a BD signal and a VDO signal.

FIG. 7 is a block diagram of an image modulating portion.

FIG. 8A and FIG. 8B are explanatory diagrams of halftone processing and PWM processing.

FIG. 9A, FIG. 9B, FIG. 9C, and FIG. 9D are explanatory diagrams of operations of linear interpolation and variable power processing performed by a variable power processing portion.

FIG. 10A, FIG. 10B, and FIG. 10C are explanatory diagrams of the halftone processing.

FIG. 11A and FIG. 11B are explanatory diagrams of bit data insertion-extraction.

FIG. 12 is a flow chart for illustrating an operation in partial magnification correction.

FIG. 13 is a flow chart for illustrating an operation of selecting a partial magnification correction method based on an original type.

FIG. 14 is a flow chart for illustrating an operation of selecting the partial magnification correction method based on an object attribute.

FIG. 15 is a table for showing output images subjected to different types of partial magnification correction.

### DESCRIPTION OF THE EMBODIMENTS

Now, an embodiment for carrying out the present invention will be described with reference to the drawings.

<Image Forming Apparatus>

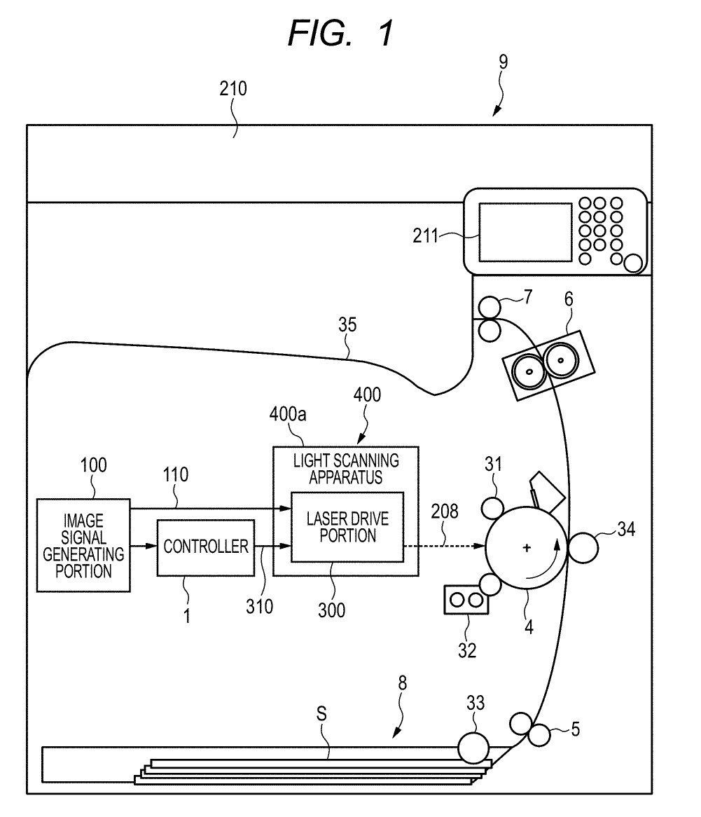

FIG. 1 is a schematic diagram of an image forming apparatus 9. The image forming apparatus 9 includes an operation portion 211 serving as a user interface (UI) to be used by a user for operation. The operation portion 211 includes buttons to be used by the user to input instructions, and a liquid crystal screen (display portion) configured to display information to the user. The image forming apparatus 9 includes an original reading portion 210 configured to read image information on an original. The original reading portion 210 is, for example, an image scanner. The image forming apparatus 9 includes a light scanning apparatus 400 as a light scanning unit configured to scan a surface of a photosensitive drum 4 serving as a photosensitive member with a light beam. The light scanning apparatus 400 includes a laser drive portion 300. The laser drive portion 300 is configured to emit a laser light beam (hereinafter referred to as “light beam”) 208 based on a VDO signal 110 serving as an image signal output from an image signal generating portion 100 and a control signal 310 output from a controller 1. The light beam 208 scans the surface of the photosensitive drum 4, which is uniformly charged by a charger 31 serving as a charging unit, to form an electrostatic latent image (hereinafter referred to as “latent image”) on the surface of the photosensitive drum 4. A developing device 32 serving as a developing unit is configured to cause a toner serving as a developer to adhere to the latent image to form a toner image. A recording medium (sheet) S, for example, a paper sheet, is received in a feeder unit 8. The recording medium S fed from the feeder unit 8 by a pickup roller 33 is conveyed to a transfer position by sheet feeding rollers 5 so as to be brought into contact with the photosensitive drum 4. The toner image is transferred onto the recording medium S conveyed to the transfer position by a transfer roller 34. The toner image transferred onto the recording medium S is heated and pressurized by a fixing device 6 to be fixed to the recording medium S. The recording medium S having an image formed thereon is delivered to a delivery tray 35 by delivery rollers 7.

<Light Scanning Apparatus>

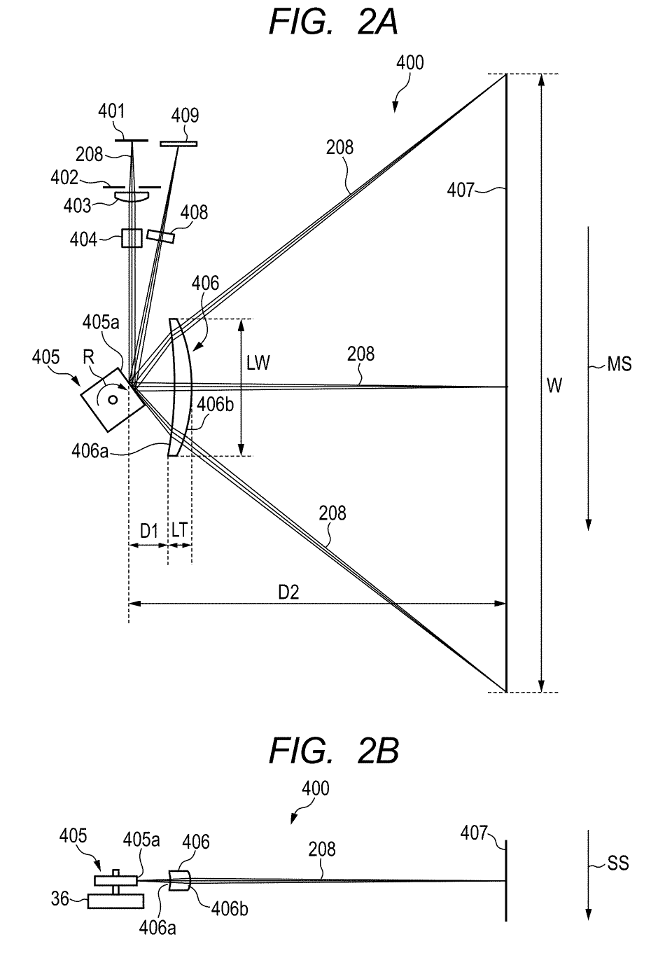

FIG. 2A and FIG. 2B are sectional views of the light scanning apparatus 400. FIG. 2A is a diagram for illustrating a main scanning section of the light scanning apparatus 400. FIG. 2B is a diagram for illustrating a sub-scanning section of the light scanning apparatus 400. The main scanning section is a cross section obtained by taking the light scanning apparatus 400 along a plane containing an optical axis of an imaging lens (imaging optical element) 406 and a main scanning direction MS. The sub-scanning section is a cross section obtained by taking the light scanning apparatus 400 along a plane containing the optical axis of the imaging lens 406 and being perpendicular to the main scanning section. The light scanning apparatus 400 includes a light source 401, a rotary polygon mirror 405 serving as a deflection device, and a casing (optical housing) 400a illustrated in FIG. 1. The light source 401 is configured to emit the light beam 208. The rotary polygon mirror 405 is configured to deflect the light beam 208 so that the light beam 208 emitted from the light source 401 scans the surface of the photosensitive drum 4 (hereinafter referred to as “scanned surface 407”). The casing 400a is mounted with the light source 401, and holds the rotary polygon mirror 405 and optical elements in the inside. In the embodiment, the light beam 208 emitted from the light source 401 is shaped to have an elliptic shape by the aperture diaphragm 402 to enter the coupling lens 403. The light beam that has passed through the coupling lens 403 is converted into substantially collimated light to enter an anamorphic lens 404. The substantially collimated light includes weak convergent light and weak divergent light. The anamorphic lens 404 has a positive refractive power within the main scanning section, and is configured to convert the incoming light beam into the light beam 208 converged within the main scanning section. The anamorphic lens 404 is also configured to condense the light beam in the vicinity of a reflection surface 405a, which serves as a deflecting surface of the rotary polygon mirror 405, within the sub-scanning section to form a line image that is long in the main scanning direction MS.

The light beam that has passed through the anamorphic lens 404 is deflected by a plurality of reflection surfaces 405a of the rotary polygon mirror 405. The light beam 208 that has been deflected by the reflection surface 405a is transmitted through the imaging lens 406 to be imaged on the scanned surface 407 as a light spot. The imaging lens 406 is an imaging optical element. In the embodiment, an imaging optical system is formed of only a single imaging optical element (imaging lens 406). The light beam 208 is imaged on the scanned surface 407 by the imaging lens 406 to form an image (light spot) having a predetermined spot shape. The rotary polygon mirror 405 is rotated in a direction indicated by an arrow R at a constant angular velocity by a motor 36 serving as a drive device. The light spot is moved on the scanned surface 407 in the main scanning direction MS in accordance with rotation of the rotary polygon mirror 405 to form a latent image on the scanned surface 407. The main scanning direction MS is a direction parallel with the surface of the photosensitive drum 4 and perpendicular to a moving direction of the surface (rotation direction) of the photosensitive drum 4. A sub-scanning direction SS is a direction perpendicular to the main scanning direction MS and the optical axis of the light beam 208.

A beam detector (hereinafter referred to as “BD”) 409 and a BD lens 408 form an optical system for generating a synchronization signal for determining a timing to write a latent image on the scanned surface 407. The light beam 208 that has passed through the BD lens 408 enters the BD 409 including a photodiode to be detected thereby. The writing timing of the light beam 208 is controlled based on the timing at which the light beam 208 is detected by the BD 409.

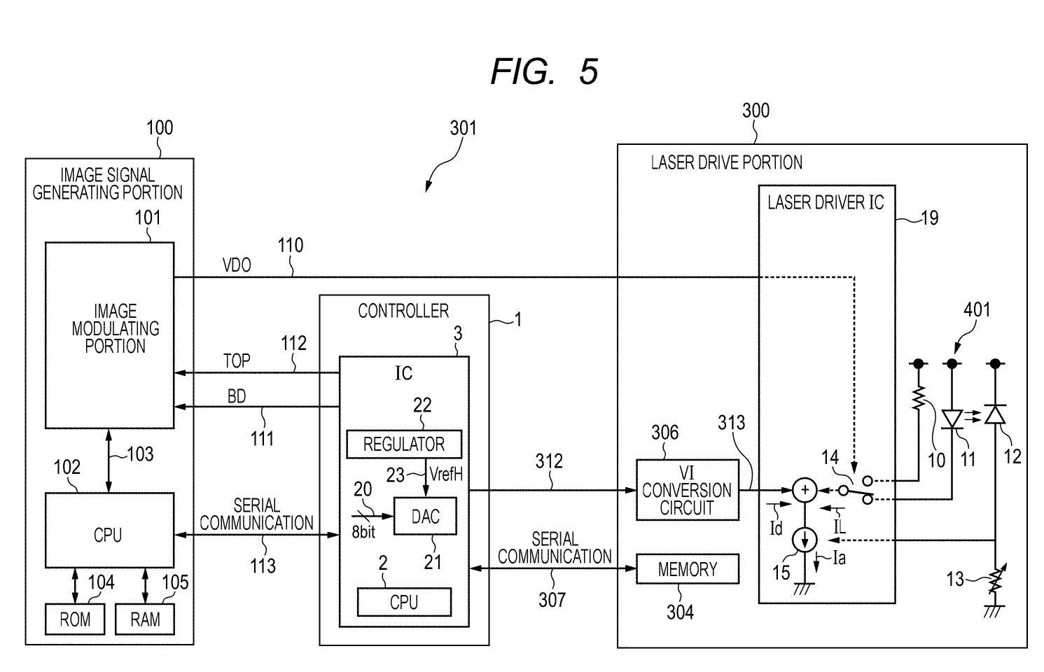

The light source 401 is a semiconductor laser chip. The light source 401 of the embodiment includes one light emitting portion 11 illustrated in FIG. 5. However, the light source 401 may include a plurality of light emitting portions capable of independently controlling light emission. Also when the plurality of light emitting portions are included, a plurality of light beams emitted from the plurality of light emitting portions each pass through the coupling lens 403, the anamorphic lens 404, the rotary polygon mirror 405, and the imaging lens 406 to reach the scanned surface 407. A plurality of light spots corresponding to the plurality of light beams are formed on the scanned surface 407 at positions displaced in the sub-scanning direction SS. The light source 401, the coupling lens 403, the anamorphic lens 404, the imaging lens 406, the rotary polygon mirror 405, and other such various optical members are held in the casing 400a of the light scanning apparatus 400 (FIG. 1).

<Imaging Lens>

As illustrated in FIG. 2A and FIG. 2B, the imaging lens 406 has two optical surfaces (lens surfaces) including an incident surface (first surface) 406a and an outgoing surface (second surface) 406b. The imaging lens 406 is configured so that, within the main scanning section, the light beam 208 deflected by the reflection surface 405a is transmitted through the imaging lens 406 to scan the scanned surface 407 with a predetermined scanning characteristic. The imaging lens 406 is also configured to change the light spot of the light beam 208 on the scanned surface 407 so as to have a predetermined shape. The imaging lens 406 is also configured to bring the vicinity of the reflection surface 405a and a vicinity of the scanned surface 407 to an optically conjugate relationship within the sub-scanning section. The imaging lens 406 is thus configured to compensate an optical face tangle error. When the reflection surface 405a of the rotary polygon mirror 405 is inclined with respect to a rotary axis of the rotary polygon mirror 405, a scanning position of the light beam 208 is deviated in the sub-scanning direction SS on the scanned surface 407. The imaging lens 406 can reduce the deviation of the scanning position, which is caused by the optical face tangle error. The imaging lens 406 of the embodiment is a plastic molded lens formed by injection molding, but a glass molded lens may be employed as the imaging lens 406. A molded lens is easy to be molded into an aspherical shape, and is suitable for mass production. It is possible to achieve improvements in productivity and optical performance of the imaging lens 406 by employing the molded lens as the imaging lens 406.

The imaging lens 406 does not have an fθ characteristic. That is, the imaging lens 406 does not have such a scanning characteristic as to image the light beam, which is passing through the imaging lens 406 while the rotary polygon mirror 405 is being rotated at a constant angular velocity, as the light spot moving on the scanned surface 407 at a constant speed. The imaging lens 406 can be arranged in proximity to the rotary polygon mirror 405 through use of the imaging lens 406 that does not have the fθ characteristic. That is, a distance D1 between the rotary polygon mirror 405 and the imaging lens 406 illustrated in FIG. 2A can be reduced. Further, the imaging lens 406 that does not have the fθ characteristic can have a width LW of the imaging lens 406 in the main scanning direction MS and a thickness LT of the imaging lens 406 in the optical axis direction made smaller than those of an imaging lens having an fθ characteristic. This enables reduction in size of the casing 400a of the light scanning apparatus 400 (FIG. 1). Further, the imaging lens having the fθ characteristic may have a part exhibiting a drastic change in shapes of an incident surface and an outgoing surface of the imaging lens in the main scanning section. Such an imaging lens may not exhibit satisfactory imaging performance due to the drastic change in the shapes of the incident surface and the outgoing surface. In contrast, the imaging lens 406 that does not have the fθ characteristic does not have the part exhibiting the drastic change in the shapes of the incident surface 406a and the outgoing surface 406b of the imaging lens 406 in the main scanning section, and can therefore exhibit satisfactory imaging performance. The scanning characteristic of the imaging lens 406 that does not have the fθ characteristic is expressed by Expression (1).

$$Y = \frac{K}{B} tan ( B θ ) \qquad ( 1 )$$

In Expression (1), θ represents an angle (hereinafter referred to as “scanning angle”) between the optical axis of the imaging lens 406 and the light beam 208 deflected by the rotary polygon mirror 405. Y (mm) represents a distance (hereinafter referred to as “image height”) between the optical axis of the imaging lens 406 and a position (focused position) of the light spot of the light beam 208 imaged on the scanned surface 407 in the main scanning direction MS. K (mm) represents an imaging coefficient (hereinafter referred to as “on-axis image height”) at an image height on the optical axis of the imaging lens 406. B represents a coefficient (hereinafter referred to as “scanning characteristic coefficient”) for determining the scanning characteristic of the imaging lens 406. The on-axis image height represents the image height on the optical axis of the imaging lens 406, and is therefore an image height Y (Y=0=Ymin) exhibited when the scanning angle θ is 0 (θ=0). In the embodiment, the image height (Y≠0) at a position (θ≠0) deviated from the optical axis (θ=0) of the imaging lens 406 is referred to as “off-axis image height”. In addition, image heights (Y=+Ymax and Y=−Ymax) at positions (θ=+θmax and θ=−θmax) being farthest from the optical axis of the imaging lens 406 (θ=0) are each referred to as “outermost off-axis image height”. A width (hereinafter referred to as “scanning width”) W of a predetermined region (hereinafter referred to as “scanning region”) that allows the latent image to be formed on the scanned surface 407 in a main scanning direction is expressed as W=|+Ymax|+|−Ymax|. The center of the scanning region corresponds to the on-axis image height. Both end portions of the scanning region each correspond to the outermost off-axis image height. A deflection angle of the light beam required for scanning the scanning region by the scanning width W corresponds to a scanning field angle.

In this case, the imaging coefficient K is a coefficient corresponding to f within a scanning characteristic (fθ characteristic) Y=fθ exhibited when collimated light enters the imaging lens 406. That is, the imaging coefficient K is a coefficient for bringing the image height Y and the scanning angle θ to a proportional relationship in the same manner as the fθ characteristic when light other than the collimated light enters the imaging lens 406. To give further details of the scanning characteristic coefficient B, Expression (1) becomes Y=Kθ when B=0, which corresponds to the scanning characteristic Y=fθ (equidistant projection method) of an imaging lens used for a related-art light scanning apparatus. Further, Expression (1) becomes Y=K tan θ when B=1, which corresponds to a projection characteristic Y=f tan θ (central projection method) of a lens used for an image pickup apparatus (camera) or the like. That is, it is possible to obtain a scanning characteristic between the projection characteristic Y=f tan θ and the fθ characteristic Y=fθ by setting the scanning characteristic coefficient B within a range of 0≤B≤1 in Expression (1).

In this case, when Expression (1) is differentiated with respect to the scanning angle θ, a scanning speed dY/dθ of the light beam on the scanned surface 407 with respect to the scanning angle θ is obtained as indicated in Expression (2).

$$\frac{dY}{d θ} = \frac{K}{{cos}^{2} ( B θ )} \qquad ( 2 )$$

According to Expression (2), the scanning speed dY/dθ at the on-axis image height (θ=0) becomes K because the scanning angle θ is 0 (θ=0). When Expression (2) is further divided by the scanning speed dY/dθ=K at the on-axis image height, Expression (3) is obtained.

$$\frac{\frac{dY}{d θ}}{K} - 1 = \frac{1}{{cos}^{2} ( B θ )} - 1 = {tan}^{2} ( B θ ) \qquad ( 3 )$$

Expression (3) indicates a deviation amount (partial magnification) of the scanning speed dY/dθ at the off-axis image height with respect to the scanning speed K at the on-axis image height. In the embodiment, the partial magnification at the image height Y is expressed as a percentage (%) of a deviation amount ((dY/dθ)/K−1) obtained by subtracting 1 from a ratio ((dY/dθ)/K) of the scanning speed dY/dθ at the off-axis image height to the scanning speed K at the on-axis image height. The scanning speed of the light beam 208 emitted from the light scanning apparatus 400 using the imaging lens 406 of the embodiment differs between at the on-axis image height (Y=0=Ymin) and at the off-axis image height Y (Y≠0) except when the scanning characteristic coefficient B is 0 (B=0).

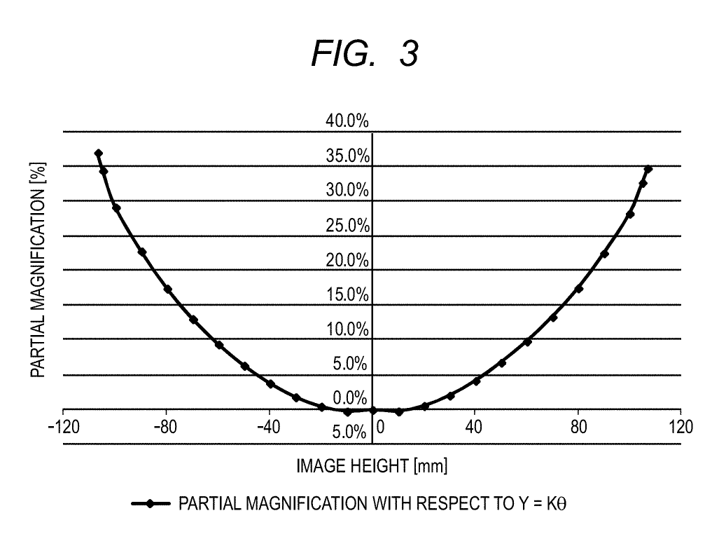

FIG. 3 is a graph for showing the partial magnification (%) with respect to the image height Y (mm) for the light scanning apparatus 400. In FIG. 3, there is shown a relationship between the image height Y and the partial magnification, which is exhibited when the image height Y on the scanned surface 407 is expressed by the scanning characteristic of Y=Kθ. When the imaging lens 406 has the scanning characteristic of Y=Kθ, as shown in FIG. 3, the partial magnification increases as the image height becomes farther from the on-axis image height (Y=0) and closer to the respective outermost off-axis image heights (Y=+Ymax and Y=−Ymax). This is because the scanning speed gradually increases as the image height becomes farther from the on-axis image height and closer to the outermost off-axis image height. For example, the partial magnification of 30% means that, when the light beam is scanned in the main scanning direction for a unit time, a length (hereinafter referred to as “scanning length”) by which the scanned surface 407 is scanned with the light beam in the main scanning direction is 1.3 times longer than a scanning length at the on-axis image height. Thus, when a pixel width in the main scanning direction is determined based on a fixed time interval determined by a cycle period of an image clock, a scanning length per pixel differs between at the on-axis image height (Y=0) and at the off-axis image height (Y≠0). Therefore, the scanning length per pixel in the main scanning direction at the off-axis image height (Y≠0) becomes longer than the scanning length per pixel in the main scanning direction at the on-axis image height (Y=0), and a pixel density changes depending on the image height (position in the main scanning direction). Further, the scanning speed gradually becomes higher as the image height Y becomes farther from the on-axis image height and closer to the outermost off-axis image height (as the absolute value of the image height Y becomes larger). Therefore, a time required for the light spot near the outermost off-axis image height to scan the scanned surface 407 by a unit length is shorter than a time required for the light spot near the on-axis image height to scan the scanned surface 407 by the unit length.

In a case of the imaging lens 406 having such an optical characteristic as described above, variations in partial magnification that depend on a main scanning position may exert adverse influence in maintaining satisfactory image quality. In view of this, in the embodiment, in order to obtain satisfactory image quality, correction of the partial magnification is performed. In particular, the scanning field angle becomes larger as an optical path length between the rotary polygon mirror 405 and the photosensitive drum 4 becomes shorter, and hence a difference between the scanning speed at the on-axis image height and the scanning speed at the outermost off-axis image height becomes larger. According to extensive investigation of the inventor of the present invention, it has been clarified that, when the light scanning apparatus 400 is reduced in size, the scanning speed at the outermost off-axis image height becomes equal to or larger than 120% of the scanning speed at the on-axis image height. In this case, the rate of change in scanning speed of the light scanning apparatus 400 is equal to or larger than 20%. In a case of such a light scanning apparatus 400, it becomes difficult to maintain satisfactory image quality due to the influence of the variations in the partial magnification depending on the main scanning position.

A rate C (%) of change in scanning speed has a value expressed as C=((Vmax−Vmin)/Vmin)*100, where Vmin represents the lowest scanning speed and Vmax represents the highest scanning speed. In the light scanning apparatus 400 of the embodiment, the scanning speed becomes the lowest scanning speed Vmin at the on-axis image height (center of the scanning region), and becomes the highest scanning speed Vmax at the outermost off-axis image height (both end portions of the scanning region). According to the extensive investigation of the inventor of the present invention, it has been clarified that the rate of change in scanning speed becomes equal to or larger than 35% when the scanning field angle is equal to or larger than 52°. Examples of a condition for the scanning field angle becoming equal to or larger than 52° are as follows.

### Example 1

The scanning width W is 214 mm (W=214 mm) when a latent image having a width equal to a short side of an A4 sheet is formed in the main scanning direction. An optical path length D2 between the reflection surface 405a and the scanned surface 407 (FIG. 2A) is equal to or shorter than 125 mm (D≤125 mm) when the scanning angle is 0°.

### Example 2

The scanning width W is 300 mm (W=300 mm) when a latent image having a width equal to a short side of an A3 sheet is formed in the main scanning direction. An optical path length D2 between the reflection surface 405a and the scanned surface 407 (FIG. 2A) is equal to or shorter than 247 mm (D2≤247 mm) when the scanning angle is 0°.

In the image forming apparatus 9 using the light scanning apparatus 400 having the scanning characteristic as shown in FIG. 3, the partial magnification correction is performed so that substantially the same scanning length per pixel in the main scanning direction is obtained on the scanned surface 407. The partial magnification correction is performed by subjecting the image data to variable power processing or subjecting the image data to bit data insertion-extraction depending on a type of an image to be printed (hereinafter referred to as “image type”). In the variable power processing, the partial magnification is corrected at a resolution in unit of one pixel. In the bit data insertion-extraction, the partial magnification is corrected at a resolution less than one pixel. The image data of one pixel is divided by a predetermined integer value. One pixel has as many pieces of bit data as the predetermined integer value. Density data of the image data is converted into a plurality of pieces of bit data (hereinafter referred to as “bit data group”) for each pixel. In the bit data insertion-extraction, the partial magnification correction is performed by inserting (adding) or extracting (deleting) the bit data to or from the bit data group. The bit data refers to each piece of bit data forming the bit data group obtained by converting the density data. The bit data insertion-extraction refers to insertion of one or more bit data to the bit data group or extraction of one or more bit data from the bit data group. The image type includes a graphic image in which gradation expression is qualitatively demanded, for example, a photograph, and a line image in which contrast and a clear contour are qualitatively demanded, for example, text or a ruled line image. In the embodiment, the graphic image includes an image having a gradation that is larger than a predetermined gradation and a continuous gradation image. The line image includes an image only having a gradation that is equal or smaller than the predetermined gradation. In the embodiment, the predetermined gradation is a 5-level gradation. However, the predetermined gradation is not limited to the 5-level gradation, and may be set to any value, for example, a 2-level gradation, a 3-level gradation, . . . , a 9-level gradation, or a 10-level gradation. When the image type is the graphic image, the partial magnification correction is performed by the variable power processing. When the image type is the line image, the partial magnification correction is performed by the bit data insertion-extraction.

In the embodiment, the partial magnification is represented as, with the on-axis image height being set as a reference position, the deviation amount of the scanning speed at a main scanning position, which is different from the reference position, with respect to the scanning speed at the on-axis image height. However, the present invention is not limited thereto, and a position different from the on-axis image height may be set as the reference position. The partial magnification correction may be executed so as to correct the partial magnification serving as the deviation amount of the scanning speed at a position, which is different from a reference position of the light beam on the surface of the photosensitive member in the main scanning direction, with respect to the scanning speed at the reference position.

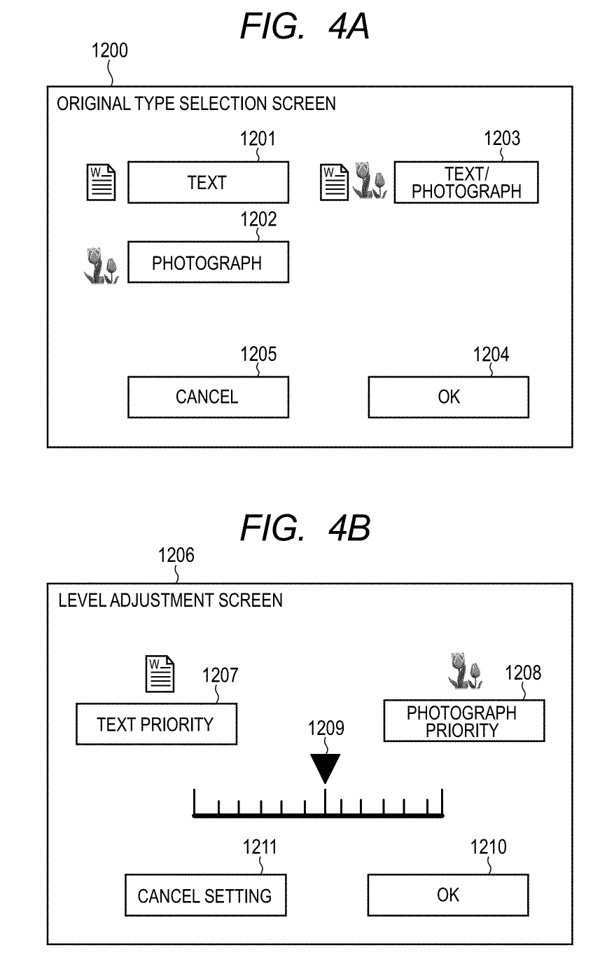

Next, a method of determining the image type will be described. FIG. 4A and FIG. 4B are explanatory diagrams of the method of determining the image type of an original in a copying operation (copy function). First, with reference to FIG. 4A and FIG. 4B, the method of determining the image type of an original (hereinafter referred to as “original type”), which is designated by the user on the operation portion 211 in the copying operation, will be described. FIG. 4A is a diagram for illustrating an original type selection screen 1200 to be displayed on the display portion of the operation portion 211 included in the image forming apparatus 9. The user can select the original type to be read in the copying operation on the original type selection screen 1200. On the original type selection screen 1200, a text original selection button 1201, a photographic original selection button 1202, and a text/photographic original selection button 1203 are arranged. On the original type selection screen 1200, an OK button 1204 for confirming the selected original type and a cancel button 1205 for canceling the selection of the original type are further arranged. When the user presses the text original selection button 1201, the original type is determined to be the line image. When the user presses the photographic original selection button 1202, the original type is determined to be the graphic image. When the user presses the text/photographic original selection button 1203, a level adjustment screen 1206 is displayed on the display portion of the operation portion 211.

FIG. 4B is a diagram for illustrating the level adjustment screen 1206 to be displayed when the text/photographic original selection button 1203 illustrated in FIG. 4A is pressed. When the original includes text and a photograph, the user presses the text/photographic original selection button 1203. In the level adjustment screen 1206, a text priority button 1207, a photograph priority button 1208, a slider 1209, an OK button 1210, and a setting cancel button 1211 are arranged. The user can intuitively input the ratio (weight) between the variable power processing and the bit data insertion-extraction in the partial magnification correction for an original including text and a photograph with use of the slider 1209 displayed on the level adjustment screen 1206. Further, when the text priority button 1207 is pressed, the slider 1209 is moved to the left by one graduation. When the slider 1209 is moved to the left, the ratio of the bit data insertion-extraction in the partial magnification correction is increased. When the photograph priority button 1208 is pressed, the slider 1209 is moved to the right by one graduation. When the slider 1209 is moved to the right, the ratio of the variable power processing in the partial magnification correction is increased. The ratio between the variable power processing and the bit data insertion-extraction in the partial magnification correction is set based on the position of the slider (ratio setting portion) 1209. For example, when the slider 1209 is located at the center, the ratios of the variable power processing and the bit data insertion-extraction in the partial magnification correction are each set to 50%. When the partial magnification is 30%, 15% of the partial magnification is corrected by the variable power processing, and 15% of the partial magnification is corrected by the bit data insertion-extraction. The OK button 1210 is pressed in order to confirm the set ratio between the variable power processing and the bit data insertion-extraction. The setting cancel button 1211 is pressed in order to cancel the set ratio between the variable power processing and the bit data insertion-extraction.

Next, the method of determining the image type in the printing operation (printing function) based on page description language data will be described. In page description language (hereinafter referred to as “PDL”) printing, the image type is determined based on an object attribute. The object attribute includes an image object, a graphic object, and a text object. Printing data formed by an application program on a client PC (not shown) is converted by a printer driver into PDL data having an attribute of, for example, the image object, the graphic object, or the text object. The image forming apparatus 9 selectively switches between the variable power processing and the bit data insertion-extraction based on the object attribute in the PDL data received from the client PC. For example, when the PDL data only has an attribute of a line image, for example, text, a ruled line image, or an image having a gradation that is equal to or less than the 5-level gradation, the partial magnification correction is performed by the bit data insertion-extraction. When the PDL data has an attribute of a graphic image, for example, a photograph, an image having a gradation that is larger than the 5-level gradation, or a continuous gradation image, the partial magnification correction is performed by the variable power processing.

The image forming apparatus 9 performs the partial magnification correction in accordance with the image type based on partial magnification correction information. The partial magnification correction is performed by the bit data insertion-extraction, the magnification processing, or both of the bit data insertion-extraction and the magnification processing depending on whether the image type is the line image or the graphic image, or the image type includes both of the line image and the graphic image. The partial magnification correction information is information including a correction degree (partial magnification correction factor) of the partial magnification, which changes depending on the position in the main scanning direction. For example, in the case of the variable power processing, the partial magnification correction factor is 1.00 at the center where the partial magnification is 0% as shown in FIG. 3. When the partial magnification correction factor is 1.00, the magnification (variable power ratio) of the variable power processing is 100% (same magnification). Further, the partial magnification correction factor is 0.74 (=100[%]/(100[%]+35[%])) at the end portion where the partial magnification is 35% as shown in FIG. 3. When the partial magnification correction factor is 0.74, the variable power ratio is 74%. The variable power ratio of 74% means that the input image is reduced to 74%. As described above, in the embodiment, the partial magnification correction processing is switched depending on the image type to be printed. In this manner, the image forming apparatus 9 using the imaging lens 406 that does not have the fθ characteristic can obtain satisfactory image quality.

<Exposure Control System>

FIG. 5 is a block diagram of an exposure control system 301 within the image forming apparatus 9. The image signal generating portion 100 includes an image modulating portion 101, a CPU (controller) 102, a ROM (storage portion) 104, and a RAM (storage portion) 105. The image signal generating portion 100 is configured to perform various operations under the control of the CPU 102. The image modulating portion 101 is connected to the CPU 102 by a bus 103. The CPU 102 is electrically connected to the ROM 104 and the RAM 105. The ROM 104 stores a program to be executed by the CPU 102. The RAM 105 stores data necessary for the execution of the program. The image signal generating portion 100 receives information including a print job from a host computer (not shown), and generates the VDO signal 110 as the image signal based on image data included in the information. The image signal generating portion 100 also has a function of that of a pixel width correction unit. The controller 1 is configured to control the image forming apparatus 9. The controller 1 also has a function of that of a brightness correction unit configured to control a light amount of the light source 401. The laser drive portion 300 is configured to supply a current to the light source 401 based on the VDO signal 110 to cause the light source 401 to emit a light beam.

The image signal generating portion 100 transmits a signal for instructing to start printing to the controller 1 through a serial communication 113 when the VDO signal 110 for image formation is ready to be output. When printing is ready to be performed, the controller 1 transmits a TOP signal 112, which is a sub-scanning synchronization signal for notifying positional information on a leading edge part of a recording medium, and a BD signal 111, which is a main scanning synchronization signal for notifying positional information on a left edge part of the recording medium, to the image signal generating portion 100. When receiving the TOP signal 112 and the BD signal 111, the image signal generating portion 100 outputs the VDO signal 110 to the laser drive portion 300 at a predetermined timing.

Next, the brightness correction to be performed to improve an image will be described. The controller 1 includes an integrated circuit (hereinafter referred to as “IC”) 3. The IC 3 has built therein a CPU 2, a DA converter (hereinafter referred to as “DAC”) 21 configured to convert an 8-bit digital signal into an analog signal, and a regulator 22. The IC 3 functions as the brightness correction unit together with the laser drive portion 300. The laser drive portion 300 includes a memory 304, a voltage/current conversion circuit (hereinafter referred to as “VI conversion circuit”) 306 configured to convert a voltage into a current, a laser driver IC 19, and the light source 401. The laser drive portion 300 supplies the drive current IL to the light emitting portion 11 being a laser diode of the light source 401. The memory (storage portion) 304 stores partial magnification characteristic information (profile) including partial magnifications corresponding to a plurality of image heights (a plurality of positions in the main scanning direction) and information on a correction current to be supplied to the light emitting portion 11. The partial magnification characteristic information may be information including the scanning speed of the light spot on the scanned surface 407 corresponding to the plurality of image heights (plurality of positions in the main scanning direction).

The information stored in the memory 304 is transmitted to the IC 3 through a serial communication 307 based on the control of the CPU 2. The IC 3 adjusts a voltage (VrefH) 23 output from the regulator 22 based on the information on the correction current to be supplied to the light emitting portion 11 stored in the memory 304. The voltage 23 serves as a reference voltage for the DAC 21. The IC 3 sets the 8-bit digital signal (input data) to be input to the DAC 21, and outputs an analog voltage for brightness correction (hereinafter referred to as “brightness correction analog voltage”) 312 in synchronization with the BD signal 111. The brightness correction analog voltage 312, which increases or decreases within the main scanning segment, is input to the VI conversion circuit 306. The VI conversion circuit 306 is configured to convert the brightness correction analog voltage 312 into a current Id 313, and to output the current Id 313 to the laser driver IC 19. In the embodiment, the IC 3 mounted to the controller 1 outputs the brightness correction analog voltage 312, but the DAC may be provided on the laser drive portion 300 to generate the brightness correction analog voltage 312 near the laser driver IC 19.

The laser driver IC 19 uses a switching circuit 14 to switch between whether to flow the drive current IL to the light emitting portion 11 or to flow the drive current IL to a dummy resistance 10 based on the VDO signal 110. The switching circuit 14 is configured to control the ON/OFF of the light emission from the light source 401 based on a VDO signal. The drive current IL (third current) supplied to the light emitting portion 11 is a current obtained by subtracting a current Id (second current) output by the VI conversion circuit 306 from a current Ia (first current) set by a constant current circuit 15. A photodiode (photoelectric conversion element) 12 is provided to the light source 401, and is configured to detect the brightness (light amount) of the light emitting portion 11. The current Ia flowing through the constant current circuit 15 is automatically adjusted by feedback control of an internal circuit of the laser driver IC 19 so that the brightness detected by the photodiode 12 becomes a predetermined brightness. The automatic adjustment of the light amount of the light emitting portion 11 is so-called automatic light amount control (auto power control: APC). The brightness adjustment of the light emitting portion 11 using the automatic adjustment of the current Ia is carried out while light is being emitted from the light emitting portion 11 in order to detect a BD signal outside a printing region for each main scanning. A variable resistor 13 has a value adjusted at a time of factory assembly so that a predetermined voltage is input from the photodiode 12 to the laser driver IC 19 when light is being emitted from the light emitting portion 11 with a predetermined brightness.

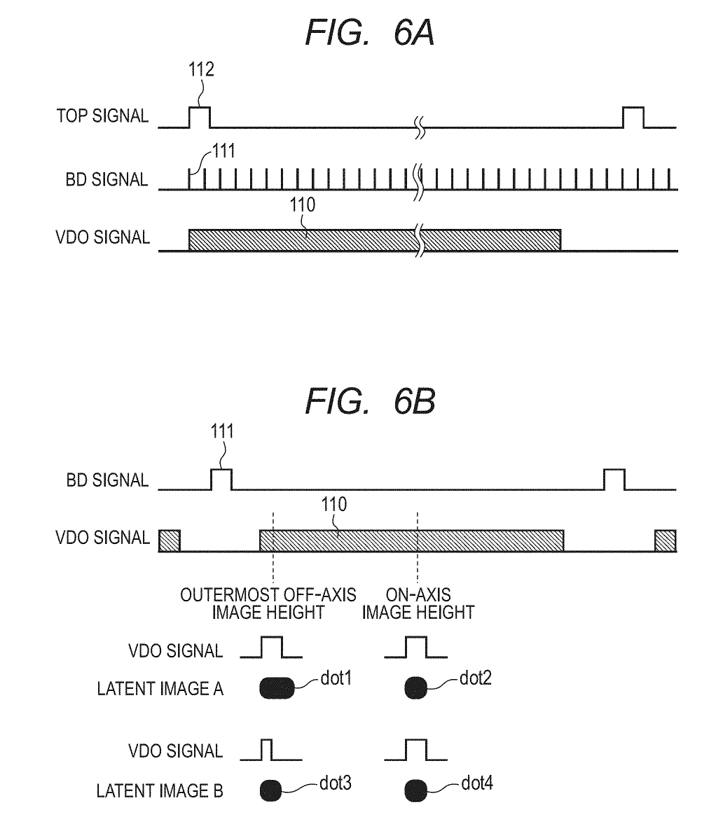

FIG. 6A and FIG. 6B are timing charts of a BD signal (synchronization signal) and a VDO signal (image signal). FIG. 6A is the timing chart of a TOP signal, a BD signal, and a VDO signal for an image forming operation corresponding to one page of a recording medium. In FIG. 6A, time elapses from the left to the right. “HIGH” of the TOP signal 112 indicates that the leading edge part of the recording medium has reached a predetermined position. When receiving “HIGH” of the TOP signal 112, the image signal generating portion 100 outputs the VDO signal 110 in synchronization with the BD signal 111. The light source 401 emits light and forms a latent image on the surface of the photosensitive drum 4 based on the VDO signal 110. In FIG. 6A, in order to simplify the illustration, the VDO signal 110 is drawn as being continuously output across a plurality of BD signals 111. However, in an actual case, the VDO signal 110 is output for a predetermined period since after the BD signal 111 is output until before the next BD signal 111 is output (FIG. 6B).

<Partial Magnification Correction>

Next, a method of correcting the partial magnification will be described. Prior to the description of the partial magnification correction, a factor of the partial magnification and a correction principle therefor will be described with reference to FIG. 6B. FIG. 6B is the timing chart of the BD signal 111 and the VDO signal 110, and is an explanatory diagram for illustrating the latent image formed on the scanned surface 407. In FIG. 6B, time elapses from the left to the right. When receiving a rising edge of the BD signal 111, the image signal generating portion 100 outputs the VDO signal 110 after a predetermined time period so as to enable formation of the latent image to be started from a writing start position spaced apart from the left edge part of the photosensitive drum 4 by a predetermined distance. The laser driver IC 19 controls the ON/OFF of the light emission from the light source 401 based on the VDO signal 110 to form the latent image on the scanned surface 407 based on the VDO signal 110.

Latent images A (latent image dot1 and latent image dot2) each having a dot shape, which are illustrated in FIG. 6B, are formed by emitting light from the light source 401 for the same period at the outermost off-axis image height and at the on-axis image height based on the VDO signal 110. The latent image dot1 and the latent image dot2 are each formed based on the VDO signal 110 corresponding to 1 dot (width of 42.3 μm in the main scanning direction) within 600 dpi. However, as described above, the light scanning apparatus 400 includes such an optical configuration that the scanning speed at the edge part (outermost off-axis image height) on the scanned surface 407 is higher than the scanning speed at the center (on-axis image height) on the scanned surface 407. When the partial magnification correction is not executed, as is clear from the latent images A (latent image dot1 and latent image dot2) illustrated in FIG. 6B, the latent image dot1 at the outermost off-axis image height is enlarged in the main scanning direction to a higher level than the latent image dot2 at the on-axis image height. In view of this, a cycle period and a time width of the VDO signal 110 are corrected based on the position in the main scanning direction, to thereby execute the partial magnification correction. Specifically, a light emission time interval at the outermost off-axis image height is made shorter than a light emission time interval at the on-axis image height to reduce the length of the latent image dot1 at the outermost off-axis image height in the main scanning direction, to thereby execute the partial magnification correction. When the partial magnification correction is executed, as in latent images B (latent image dot3 and latent image dot4) illustrated in FIG. 6B, the length of the latent image dot3 at the outermost off-axis image height in the main scanning direction becomes the same as the length of the latent image dot4 at the on-axis image height in the main scanning direction. With the partial magnification correction, latent images corresponding to the respective pixels and having the same-dimension dot shape can be formed substantially at equal intervals in the main scanning direction. In this manner, even the image forming apparatus 9 using the imaging lens 406, which does not have the fθ characteristic, can form a normal image. Next, description is given of the partial magnification correction of the embodiment in which the light emission time of the light source 401 is reduced depending on the distance from the on-axis image height (amount of increase) along with separation from the on-axis image height toward the outermost off-axis image height.

<Image Modulating Portion>

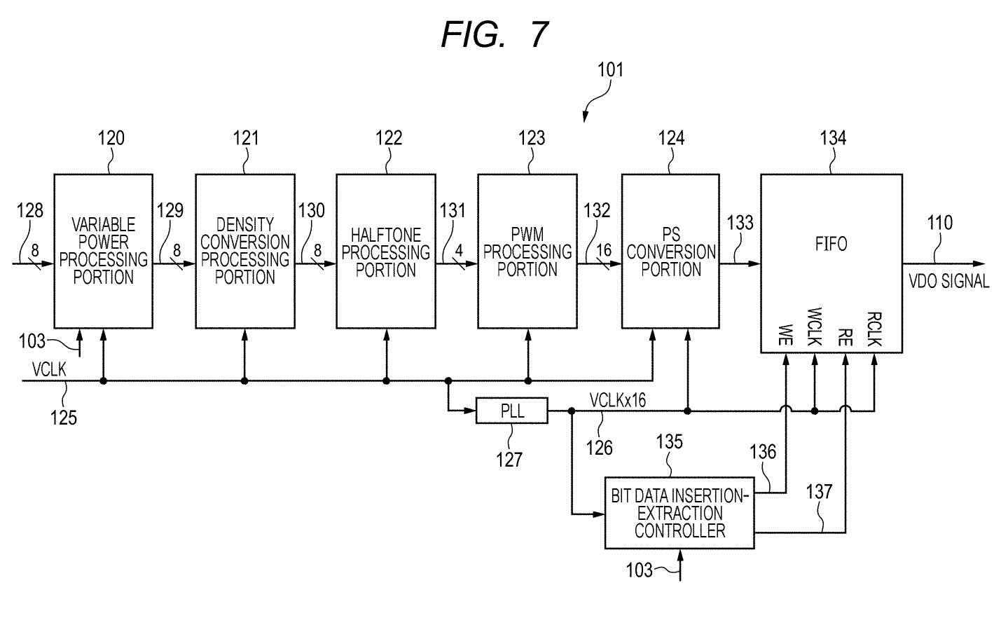

FIG. 7 is a block diagram of the image modulating portion 101. The image modulating portion 101 includes a variable power processing portion 120, a density conversion processing portion 121, a halftone processing portion 122, a PWM processing portion 123, a parallel-serial conversion portion 124, a phase locked loop (hereinafter referred to as “PLL”) 127, a FIFO 134, and a bit data insertion-extraction controller 135. A clock (VCLK) 125 corresponding to one pixel is input to the variable power processing portion 120, the density conversion processing portion 121, the halftone processing portion 122, the PWM processing portion 123, the parallel-serial conversion portion (hereinafter referred to as “PS conversion portion”) 124, and the PLL 127. The PLL 127 outputs a clock (VCLK×16) 126 obtained by multiplying the frequency of the clock (VCLK) 125 corresponding to one pixel by 16 to the PS conversion portion 124, the FIFO 134, and the bit data insertion-extraction controller 135.

In the partial magnification correction of the embodiment, when the image type is the graphic image, the variable power processing portion 120 performs variable power processing on input image data (8 bits) 128 for each section in the main scanning direction based on the partial magnification correction information. The partial magnification correction information includes the partial magnification correction factor corresponding to each of the plurality of sections in the main scanning direction. A variable power ratio is obtained from the partial magnification correction factor for each section in the main scanning direction, and the input image data (8 bits) 128 is magnified for each pixel based on the variable power ratio. The density conversion processing portion 121 includes a density correction table for performing printing at an appropriate density. The density conversion processing portion 121 uses the density correction table to subject image data (8 bits) 129 subjected to variable power processing for each section to density conversion processing. The halftone processing portion 122 subjects image data (8 bits) 130, which has been subjected to the density conversion processing, to halftone processing by dithering, and outputs multilevel parallel 4-bit image data 131. The PWM processing portion 123 includes a table for pulse width modulation processing (hereinafter referred to as “PWM processing”) for converting the image data 131 subjected to the halftone processing into information for controlling ON/OFF of the light emitting portion 11 of the light source 401. The PWM processing portion 123 uses the table for the PWM processing to subject the image data (4 bits) 131 to PWM processing.

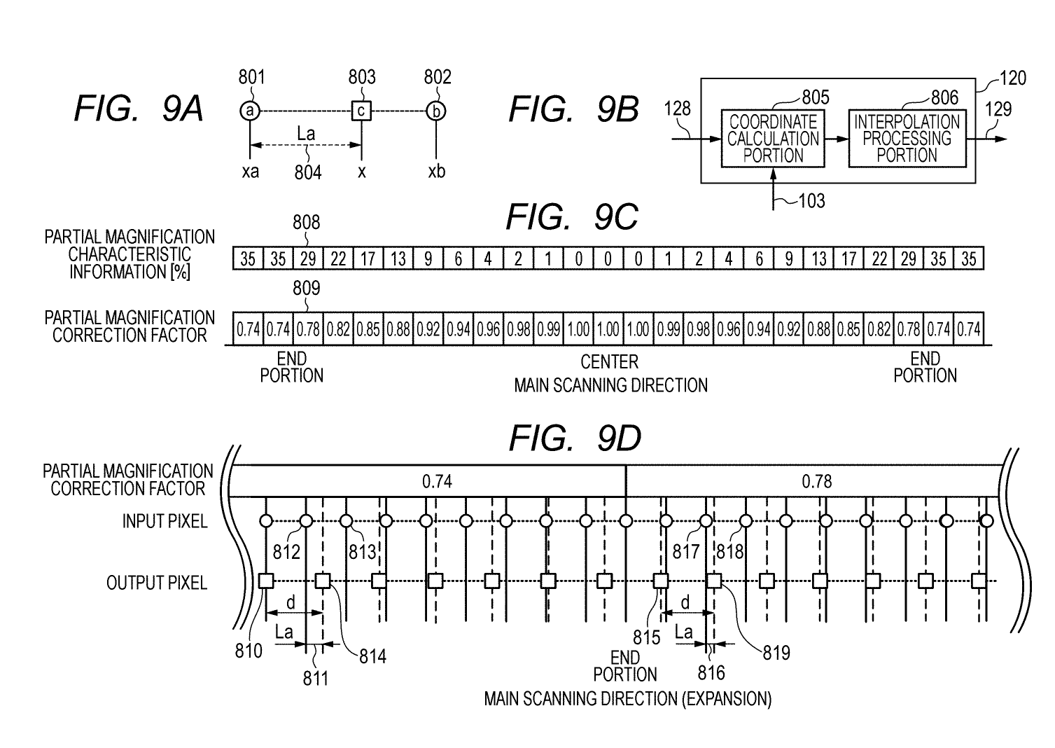

Image data (16 bits) 132 subjected to the PWM processing is a parallel signal. The PS conversion portion 124 converts the image data (16 bits) 132 subjected to the PWM processing into a serial signal 133. The FIFO 134 receives the serial signal 133 to accumulate the serial signal 133 in a line buffer (not shown), and outputs the VDO signal 110 as the serial signal to the laser drive portion 300 after a predetermined time period. The bit data insertion-extraction controller 135 receives the partial magnification characteristic information from the CPU 102 via the bus 103. The bit data insertion-extraction controller 135 controls storage (writing) and extraction (reading) of the FIFO 134 by a write enable signal (WE) 136 and a read enable signal (RE) 137 based on the partial magnification characteristic information. The variable power processing will be described later with reference to FIG. 9A, FIG. 9B, FIG. 9C, and FIG. 9D.

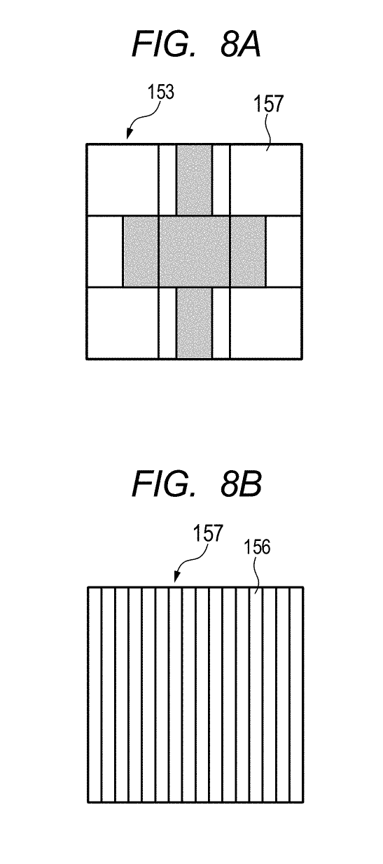

FIG. 8A and FIG. 8B are explanatory diagrams of the halftone processing and the PWM processing. FIG. 8A is a diagram for illustrating a screen of the image data 132 after being subjected to the halftone processing and the PWM processing. The screen is a 200-line matrix 153 that has 3 pixels in the main scanning direction and 3 pixels in the sub-scanning direction. The density of the image data 132 is expressed by the matrix 153. In FIG. 8A, the white part is a part in which the light source 401 is not caused to emit light (turned off), and the black part is a part in which the light source 401 is caused to emit light (turned on). A matrix 153 different from the matrix 153 illustrated in FIG. 8A is provided for each gradation. The matrix 153 expresses the gradation by a ratio in area between the black part and the white part. That is, the gradation is increased (density is increased) as the area of the black part of the matrix 153 is increased. In the embodiment, one pixel 157 is a unit for sectioning the image data in order to form one dot of 600 dpi on the scanned surface 407. FIG. 8B is a diagram for illustrating the pixel 157 subjected to the PWM processing and bit data 156. In the embodiment, one pixel is divided into 16 pieces as the PWM processing. That is, one pixel is expressed by 16-bit data. As a matter of course, one pixel may be divided into 32 pieces. Further, one pixel may be divided into other numbers of bits. FIG. 8B is an illustration of one pixel 157 divided into 16 pieces of bit data 156 for PS conversion. As illustrated in FIG. 8B, one pixel includes 16 pieces of bit data 156 each having a width of 1/16 of the width of one pixel 157. The ON/OFF of the light emission of the light source 401 is switched for each piece of bit data 156. That is, a gradation having 16 steps can be expressed with one pixel 157.

<Variable Power Processing>

Next, with reference to FIG. 9A, FIG. 9B, FIG. 9C, and FIG. 9D, the operation of the variable power processing portion 120 will be described. In the following, a case in which a linear interpolation method is used as the method of the variable power processing will be described. FIG. 9A, FIG. 9B, FIG. 9C, and FIG. 9D are explanatory diagrams of the operations of the linear interpolation processing and the variable power processing performed by the variable power processing portion 120. FIG. 9A is an explanatory diagram of the linear interpolation processing. When input pixels 801 and 802 and an output pixel 803 are arranged in a positional relationship as illustrated in FIG. 9A, a pixel value “c” of the output pixel 803 is derived by Expression (4) through the linear interpolation processing.

c==a×(1−La)+b×La (4)

In Expression (4), “a” represents a pixel value of the input pixel 801 in the vicinity (on the left side) of the output pixel 803, “b” represents a pixel value of the input pixel 802 in the vicinity (on the right side) of the output pixel 803, and La represents a phase of the output pixel 803 with respect to the input pixels 801 and 802 as indicated by reference symbol 804 in FIG. 9A.

In this case, when the position of the input pixel 801 in the main scanning direction is represented by “xa”, the position of the input pixel 802 in the main scanning direction is represented by “xb”, and the position of the output pixel 803 in the main scanning direction is represented by “x”, the phase La is derived by Expression (5).

L a=(x−x a)÷(x b−x a) (5)

As shown in Expression (4) and Expression (5), the pixel values a and b of the input pixels 801 and 802 are weighted based on the positional relationship between the output pixel 803 after the variable power processing and the input pixels 801 and 802 before the variable power processing, which are in the vicinity of the output pixel 803. In this manner, the pixel value “c” of the output pixel 803 is derived.

FIG. 9B is a block diagram of the variable power processing portion 120. The variable power processing portion 120 includes a coordinate calculation portion 805 and an interpolation processing portion 806. The coordinate calculation portion 805 is electrically connected to the CPU 102 via the bus 103. The CPU 102 inputs, to the coordinate calculation portion 805, the partial magnification characteristic information (profile) stored in the memory 304 of the laser drive portion 300. The coordinate calculation portion 805 generates partial magnification correction information based on the partial magnification characteristic information. The partial magnification correction information includes a plurality of partial magnification correction factors respectively set for a plurality of sections that are divided in the main scanning direction. The input image data 128 is input to the coordinate calculation portion 805. The coordinate calculation portion 805 derives, from the input image data 128, the position in the main scanning direction and the position in the sub-scanning direction based on the count number of the input pixel and the number of pixels of the input pixel in the main scanning direction. Further, the coordinate calculation portion 805 derives the position “x” of the output pixel in the main scanning direction based on the partial magnification correction information. Then, the coordinate calculation portion 805 derives the positions “xa” and “xb” of the input pixels, which are in the vicinity of the output pixel, in the main scanning direction based on the position “x” of the output pixel in the main scanning direction, and derives the pixel values a and b of the input pixels located at the positions xa and xb. Further, the coordinate calculation portion 805 derives the phase La with use of Expression (5) based on the position “x” of the output pixel in the main scanning direction and the positions “xa” and “xb” of the input pixels, which are in the vicinity of the output pixel, in the main scanning direction. The interpolation processing portion 806 derives the pixel value “c” of the output pixel with use of Expression (4) based on the phase La and the pixel values a and b of the input pixels in the vicinity of the output pixel, which are derived by the coordinate calculation portion 805. As described above, the variable power processing portion 120 outputs the image data 129 subjected to the variable power processing to the density conversion processing portion 121.

Now, with reference to FIG. 9C and FIG. 9D, the variable power processing performed on the input image data 128 based on partial magnification characteristic information 808 will be described. FIG. 9C is a diagram for illustrating the partial magnification characteristic information 808 and the partial magnification correction factor. The partial magnification correction factor illustrated in FIG. 9C constructs partial magnification correction information 809 for the variable power processing. The partial magnification characteristic information 808 of the embodiment includes partial magnifications for respective sections in the main scanning direction, which are obtained based on the relationship of the partial magnification with respect to the image height Y shown in FIG. 3. In this case, the partial magnification characteristic information 808 is divided into 25 sections in the main scanning direction. The partial magnification characteristic information 808 includes partial magnifications corresponding to the respective sections. When the partial magnification characteristic information 808 is to be generated, the number of sections to be divided in the main scanning direction and the width of the divided section may be set as appropriate based on the position in the main scanning direction. The partial magnification characteristic information 808 is divided into a large number of small sections so that the variable power processing can be performed with higher accuracy. Meanwhile, the partial magnification correction information 809 is information including the partial magnification correction factors derived by the coordinate calculation portion 805 based on the partial magnifications, and includes the partial magnification correction factors corresponding to the respective 25 divided sections. The position “x” of the output pixel in the main scanning direction is derived as described below based on the partial magnification correction factor.

FIG. 9D is an explanatory diagram of the operation in the variable power processing using the partial magnification correction factor illustrated in FIG. 9C. In this case, the variable power processing at positions at which the partial magnification correction factors are 0.74 and 0.78 (end portions in the main scanning direction) will be described. In FIG. 9D, the position of the input pixel in the main scanning direction is indicated by “∘”, and the position of the output pixel is indicated by “□”. A distance “d” between the output pixels in the main scanning direction when the input pixels are input at certain time intervals as illustrated in FIG. 9D is expressed by Expression (6).

$$d = \frac{1}{PARTIAL MAGNIFICATION CORRECTION FACTOR} \qquad ( 6 )$$

For example, the distance “d” between output pixels 810 and 814 in a section in which the partial magnification correction factor is 0.74 is 1.35 (d=1/0.74). Similarly, the distance “d” between output pixels 815 and 819 in a section which is adjacent to the above-mentioned section and in which the partial magnification correction factor is 0.78 is 1.28 (d=1/0.78). As described above, the distance “d” between the output pixels can be derived based on the partial magnification correction factor that differs depending on the section in the main scanning direction. The distance “d” between the output pixels is a magnitude obtained when the distance between the input pixels is 1.

When the position of the n-th output pixel (“n” is a natural number) in the main scanning direction is represented by “x”, “x” is expressed by Expression (7) with use of the distance “d” between the output pixels.

x=Σₖ₌₁ⁿ⁻¹d[k] (7)

In Expression (7), d[k] represents a distance between the output pixels with respect to a k-th output pixel in the main scanning direction, specifically, a distance between the k-th output pixel in the main scanning direction and the (k−1)-th output pixel in the main scanning direction. As shown in Expression (6), the value of the distance “d” is updated based on the section in the main scanning direction.

The positions “xa” and “xb” of the input pixels, which are in the vicinity of the output pixel, in the main scanning direction are expressed by Expression (8) and Expression (9) with use of the position “x” of the output pixel in the main scanning direction.

x a==[x] (8)

xb=x a+1 (9)

As shown in Expression (8), the position “x” of the output pixel in the main scanning direction is rounded down to the nearest integer so that the position “xa” of the input pixel in the vicinity (on the left side) of the output pixel is derived. Further, the distance between the input pixels is 1, and hence by adding 1 to “xa” as shown in Expression (9), the position “xb” of the input pixel in the vicinity (on the right side) of the output pixel is derived. The phase La to be used in the linear interpolation processing is derived with use of Expression (5) based on the derived position “x” of the output pixel and the derived positions “xa” and “xb” of the input pixels. The pixel value “c” of the output pixel is derived with use of Expression (4) based on the derived phase La.

With the above-mentioned calculation, for example, the pixel value of the output pixel 814 in the section in which the partial magnification correction factor is 0.74 in FIG. 9D is derived with use of Expression (4) based on the pixel values of input pixels 812 and 813 and the value La of a phase 811. Similarly, the pixel value of the output pixel 819 in the section in which the partial magnification correction information is 0.78 is also derived with use of Expression (4) based on the pixel values of input pixels 817 and 818 and the value La of a phase 816.

As described above, in the embodiment, the position of the output pixel in the main scanning direction and the pixel value thereof are derived while updating the value of the distance “d” between the output pixels based on the section set along the main scanning direction. In this manner, the variable power processing can be executed with a variable power ratio appropriate for each section. In the embodiment, the linear interpolation method is used as the method of the variable power processing, but other methods such as a cubic convolution interpolation method may be used instead.

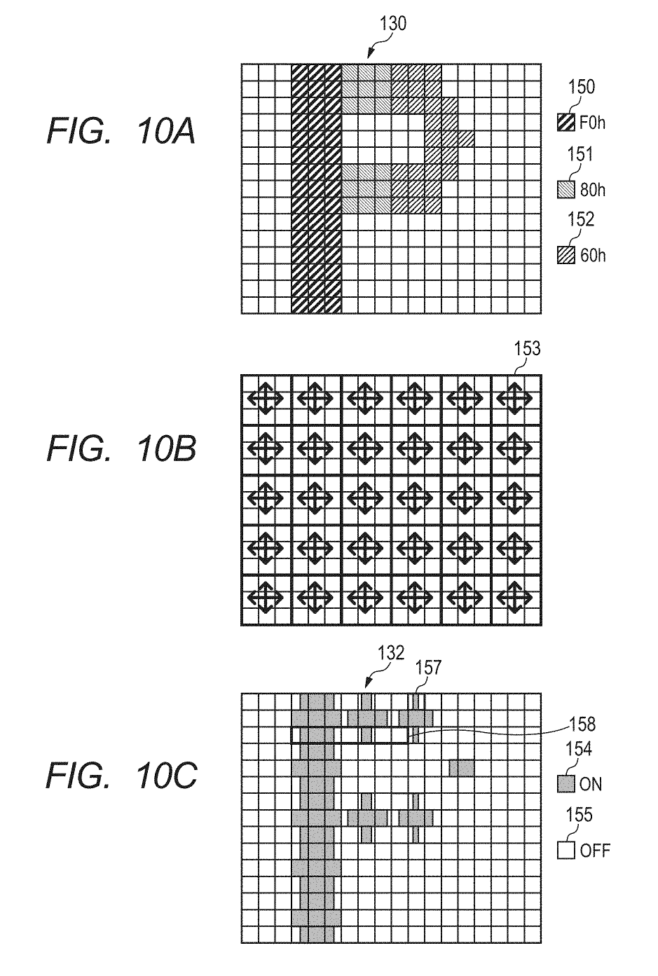

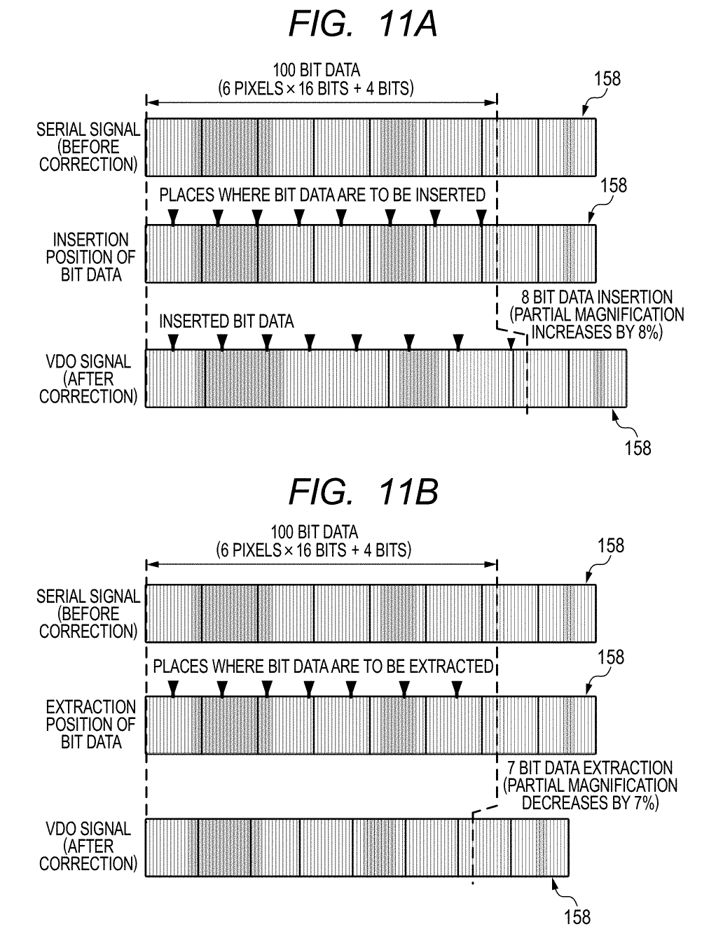

Next, with reference to FIG. 10A, FIG. 10B, FIG. 10C, FIG. 11A, and FIG. 11B, processing from the multilevel parallel 8-bit image data 130 that is input to the halftone processing portion 122 to the VDO signal 110 that is output from the FIFO 134 will be described. FIG. 10A, FIG. 10B, and FIG. 10C are explanatory diagrams of the halftone processing. FIG. 10A is a diagram for illustrating the multilevel parallel 8-bit image data 130 that is input to the halftone processing portion 122. Each pixel has 8-bit density information. A pixel 150 has density information of F0h, a pixel 151 has density information of 80h, a pixel 152 has density information of 60h, and a white part has density information of 00h. FIG. 10B is a diagram for illustrating the matrix 153. The matrix 153 is a 200-line screen that grows from the center as described with reference to FIG. 8A. FIG. 10C is a diagram for illustrating the parallel 16-bit image data 132 subjected to the halftone processing and the PWM processing. As described above, each pixel 157 includes 16 pieces of bit data. The parallel 16-bit image data 132 is converted into the serial signal 133 by the PS conversion portion 124.

<Bit Data Insertion-Extraction>

FIG. 11A and FIG. 11B are explanatory diagrams of the bit data insertion-extraction. FIG. 11A and FIG. 11B are illustrations of the serial signal 133 corresponding to an area 158 of 8 pixels arranged in the main scanning direction as illustrated in FIG. 10C. FIG. 11A is an example in which an image is enlarged in the main scanning direction by inserting the bit data into the serial signal 133. FIG. 11B is an example in which the image is reduced in the main scanning direction by extracting the bit data from the serial signal 133. The bit data insertion-extraction is performed by the bit data insertion-extraction controller 135 controlling the FIFO 134 based on the partial magnification characteristic information input from the CPU 102 via the bus 103.

As illustrated in FIG. 11A, 8 pieces of bit data are inserted into a group of 100 successive pieces of bit data of the serial signal 133 at equal or substantially equal intervals. In this manner, the pixel width is changed so that the partial magnification is increased by 8%, and the latent image is enlarged in the main scanning direction. As illustrated in FIG. 11B, 7 pieces of bit data are extracted from the group of 100 successive pieces of bit data of the serial signal 133 at equal intervals or substantially equal intervals. In this manner, the pixel width is changed so that the partial magnification is decreased by 7%, and the latent image is reduced in the main scanning direction. As described above, in the partial magnification correction by the bit data insertion-extraction, the scanning length in the main scanning direction is changed in a pixel width unit that is smaller than one pixel, and the dot-shaped latent images corresponding to the respective pixels of the image data are formed at substantially equal intervals in the main scanning direction. The description “substantially equal intervals in the main scanning direction” is herein used to mean that a case in which the respective pixels are not arranged at equal intervals in the main scanning direction is also included. That is, as a result of the partial magnification correction, the pixel intervals may have variations to some extent, and it suffices that the pixel intervals are equal on average within a predetermined image height range. As described above, when the bit data is inserted or extracted at equal or substantially equal intervals, and two adjacent pixels are compared with each other in the number of pieces of bit data that form the pixel, the difference in the number of pieces of bit data that form the pixel is 0 or 1. Therefore, the image data obtained by subjecting the original image data to the partial magnification correction can have less variation in the image density in the main scanning direction, and satisfactory image quality can be obtained. Further, the position at which the bit data is inserted or extracted may be the same position for each scanning line in the main scanning direction, or the position may be deviated.

In the imaging lens 406 of the embodiment, the scanning speed is increased as the absolute value of the image height Y is increased. In view of this, in the partial magnification correction by the bit data insertion-extraction, the bit data is inserted to and/or extracted from the serial signal 133 so that the image is reduced (scanning length of one pixel is reduced) as the absolute value of the image height Y is increased. As described above, the latent images corresponding to the respective pixels can be formed at substantially equal intervals in the main scanning direction, and thus the partial magnification can be appropriately corrected.

<Operation in Partial Magnification Correction>

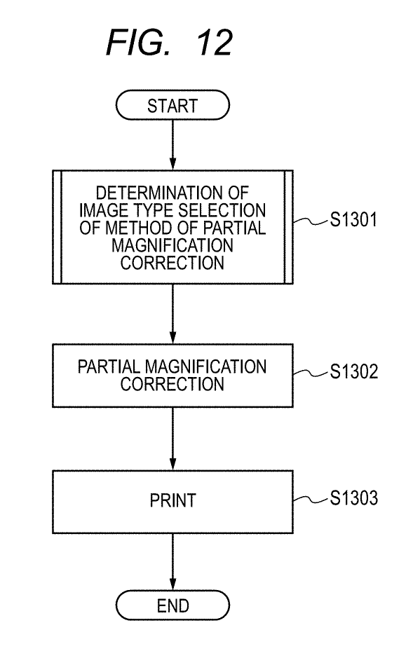

Next, with reference to FIG. 12, the operation in the partial magnification correction will be described. FIG. 12 is a flow chart for illustrating the operation in the partial magnification correction. The CPU (controller) 102 serving as a partial magnification correction unit executes the operation in the partial magnification correction based on the program stored in the ROM (storage medium) 104. When the operation in the partial magnification correction is started, the CPU 102 determines the image type, and selects the method of the partial magnification correction based on the determined image type (Step (hereinafter abbreviated as “S”) 1301). The CPU 102 performs the partial magnification correction by the method selected based on the image type (S1302). The CPU 102 performs the printing (S1303). The CPU 102 ends the operation in the partial magnification correction.

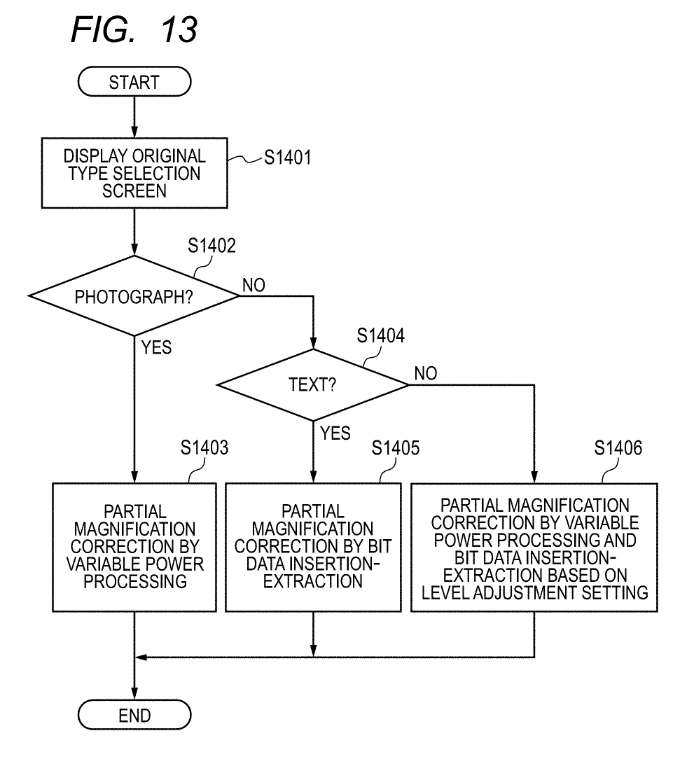

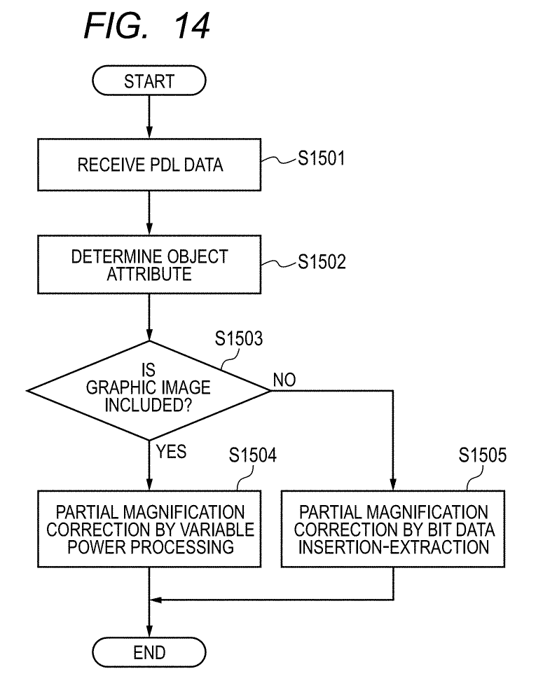

Next, the determination of the image type and the selection of the partial magnification correction method in S1301 will be described. In the embodiment, in the case of the copying operation, the image type is determined based on the original type designated with use of the operation portion 211, and the partial magnification correction method is selected based on the determined image type (FIG. 13). In the case of the PDL printing operation, the image type is determined based on the object attribute of the PDL data, and the partial magnification correction method is selected based on the determined image type (FIG. 14).

First, with reference to FIG. 13, the determination of the image type and the selection of the partial magnification correction method in the copying operation will be described. FIG. 13 is a flow chart for illustrating an operation of selecting the partial magnification correction method based on the original type. The CPU 102 executes the operation of selecting the partial magnification correction method based on the original type in accordance with the program stored in the ROM (storage medium) 104. When the operation of selecting the partial magnification correction method based on the original type is started in the copying operation, the CPU 102 causes the display portion of the operation portion 211 to display the original type selection screen 1200 illustrated in FIG. 4A (S1401). The CPU 102 determines whether or not the photographic original selection button 1202 of the original type selection screen 1200 is pressed (S1402). When the photographic original selection button 1202 is pressed, the original type (image type of the original) is determined to be the graphic image. When the photographic original selection button 1202 is pressed (YES in S1402), the CPU 102 selects the variable power processing as the partial magnification correction method (S1403). When the photographic original selection button 1202 is not pressed (NO in S1402), the CPU 102 determines whether or not the text original selection button 1201 is pressed (S1404). When the text original selection button 1201 is pressed, the original type (image type of the original) is determined to be the line image. When the text original selection button 1201 is pressed (YES in S1404), the CPU 102 selects the bit data insertion-extraction as the partial magnification correction method (S1405). When the text original selection button 1201 is not pressed (NO in S1404), the CPU 102 selects the partial magnification correction based on the ratio between the variable power processing and the bit data insertion-extraction, the ratio being set in the level adjustment screen 1206 illustrated in FIG. 4B (S1406). The CPU 102 ends the operation of selecting the partial magnification correction method based on the original type.

Next, with reference to FIG. 14, the determination of the image type and the selection of the partial magnification correction method in the PDL printing operation will be described. FIG. 14 is a flow chart for illustrating the operation of selecting the partial magnification correction method based on the object attribute. The CPU 102 executes the operation of selecting the partial magnification correction method based on the object attribute in accordance with the program stored in the ROM (storage medium) 104. When the operation of selecting the partial magnification correction method based on the object attribute is started in the PDL printing operation, the CPU 102 receives the PDL data (S1501). The CPU 102 (image type determination portion) determines the object attribute of the PDL data (S1502). The CPU 102 determines whether or not the graphic image is included in the object attribute (S1503). The graphic image is a photograph or an image having a gradation that is larger than a predetermined gradation. When the graphic image is included in the object attribute (YES in S1503), the CPU 102 selects the variable power processing as the partial magnification correction method (S1504). The variable power processing is suitable for partial magnification correction of a graphic image in which gradation expression is qualitatively demanded, for example, a photograph or an image having a gradation that is larger than a predetermined gradation. When the graphic image is not included in the object attribute (NO in S1503), the CPU 102 selects the bit data insertion-extraction as the partial magnification correction method (S1505). The bit data insertion-extraction is suitable for partial magnification correction of a line image in which contrast and a clear contour are qualitatively demanded, for example, text, a ruled line image, or an image only having a gradation that is equal to or smaller than the predetermined gradation.

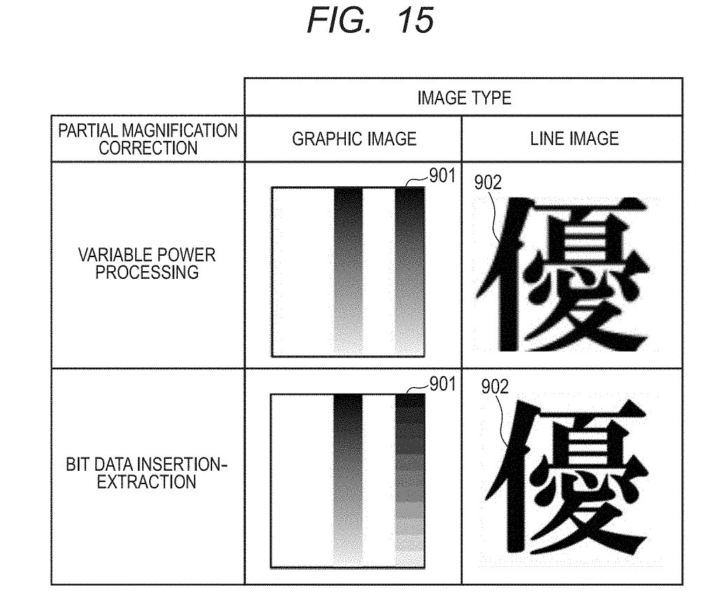

FIG. 15 is a table for showing output images subjected to different types of partial magnification correction. FIG. 15 is a table for showing output images of a case in which each of the graphic image and the line image is subjected to the partial magnification correction by the variable power processing and the bit data insertion-extraction. As the image type, a graphic image in which gray scales are printed at the center portion and the end portion of the recording medium, and a line image in which a Japanese kanji character of “ [symbol] ” (which means tenderness or superiority in Japanese) is printed are prepared. When the image type is the “graphic image”, referring to an end portion 901 of the recording medium for comparison, the partial magnification correction by the variable power processing can suppress the gradation step, which is seen in the case of the partial magnification correction by the bit data insertion-extraction. Meanwhile, when the image type is the “line image”, referring to an edge portion 902 of the kanji character of “ [symbol] ” for comparison, the partial magnification correction by the bit data insertion-extraction can suppress deterioration of a sense of resolution (a visual resolution) at the edge portion, which is seen in the case of the partial magnification correction by the variable power processing.

According to the embodiment, the partial magnification correction method is switched depending on the image type of the image to be printed, and thus image quality deteriorations such as gradation step in a gradation expression and reduction in sense of resolution can be suppressed. Further, according to the embodiment, the partial magnification correction method can be selected based on the image type.

### Other Embodiment

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, the partial magnification correction method can be selected based on the image type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-235716, filed Dec. 5, 2016, which is hereby incorporated by reference herein in its entirety.

What is claimed is:

1. An image forming apparatus, which is configured to form an image on a recording medium, the image forming apparatus comprising:
a light source configured to emit a light beam based on an image signal generated from image data;
a deflection device configured to deflect the light beam so that the light beam emitted from the light source scans a surface of a photosensitive member in a main scanning direction;
a lens configured to image the light beam deflected by the deflection device on the surface of the photosensitive member; and
a controller configured to execute partial magnification correction for correcting a partial magnification as a deviation amount of a scanning speed of the light beam at a position, which is different from a reference position on the surface of the photosensitive member in the main scanning direction, with respect to a scanning speed of the light beam at the reference position,
wherein the controller is configured to:
execute, when an image type of the image is a line image, the partial magnification correction on the image signal at a resolution less than one pixel; and
execute, when the image type is a graphic image, the partial magnification correction on the image signal at a resolution in unit of one pixel.

2. An image forming apparatus according to claim 1, further comprising an image signal generating portion configured to generate the image signal as a bit data group obtained by dividing the image data by a predetermined integer value for each pixel,
wherein, in the partial magnification correction at the resolution less than one pixel, the partial magnification is corrected by inserting one or more bit data into the bit data group or extracting one or more bit data from the bit data group, and
wherein, in the partial magnification correction at the resolution in unit of one pixel, the partial magnification is corrected by performing variable power processing for each pixel.

3. An image forming apparatus according to claim 1, further comprising a ratio setting portion configured to set a ratio between the partial magnification correction at the resolution less than one pixel and the partial magnification correction at the resolution in unit of one pixel,
wherein, when the image type includes the line image and the graphic image, the controller executes, on the image signal, the partial magnification correction at the resolution less than one pixel and the partial magnification correction at the resolution in unit of one pixel based on the ratio set by the ratio setting portion.

4. An image forming apparatus according to claim 1, further comprising a display portion configured to display a screen configured to select the image type.

5. An image forming apparatus according to claim 1, further comprising a determination portion configured to determine the image type based on an attribute of the image data.

6. An image forming apparatus according to claim 5, wherein the image data comprises page description language data.

7. An image forming apparatus according to claim 1, wherein the line image comprises a text, a ruled line image, or the text and the ruled line image, and
wherein the graphic image comprises a photograph.

8. An image forming apparatus, which is configured to form an image on a recording medium, the image forming apparatus comprising:
a light source configured to emit a light beam based on an image signal generated from image data;
a deflection device configured to deflect the light beam so that the light beam emitted from the light source scans a surface of a photosensitive member in a main scanning direction;
a lens configured to image the light beam deflected by the deflection device on the surface of the photosensitive member; and
a controller configured to execute partial magnification correction for correcting a partial magnification as a deviation amount of a scanning speed of the light beam at a position, which is different from a reference position on the surface of the photosensitive member in the main scanning direction, with respect to a scanning speed of the light beam at the reference position,
wherein the controller is configured to:
execute, when the image is an image without a gradation larger than a predetermined gradation, the partial magnification correction on the image signal at a resolution less than one pixel; and
execute, when the image is an image with a gradation larger than the predetermined gradation, the partial magnification correction on the image signal at a resolution in unit of one pixel.

9. An image forming apparatus according to claim 8, further comprising an image signal generating portion configured to generate the image signal as a bit data group obtained by dividing the image data by a predetermined integer value for each pixel,
wherein, in the partial magnification correction at the resolution less than one pixel, the partial magnification is corrected by inserting one or more bit data into the bit data group or extracting one or more bit data from the bit data group, and
wherein, in the partial magnification correction at the resolution in unit of one pixel, the partial magnification is corrected by performing variable power processing for each pixel.

10. An image forming apparatus according to claim 8,
wherein the image without the gradation larger than the predetermined gradation comprises a text, a ruled line image, or the text and the ruled line image, and
wherein the image with the gradation larger than the predetermined gradation comprises a photograph.
